(19) United States
(12) Patent Application Publication
(10) Pub. No.: US 2009/0233011 A1
(43) Pub. Date: Sep. 17, 2009

(54) Dust-free diffusion plate for liquid crystal display units and method for producing the same

(76) Inventors: Kwang Suck Suh, Seongnam (KR); Jong Eun Kim, Seoul (KR); Tae Young Kim, Seoul (KR)

Correspondence Address: PARK LAW FIRM, 3255 WILSHIRE BLVD, SUITE 1110, LOS ANGELES, CA, 90010, US

(21) Appl. No.: 11/597,864

(22) PCT Filed: May 30, 2005
(86) PCT No.: PCT/KR2005/001594

§ 371 Date: Sep. 18, 2008

(30) Foreign Application Priority Data
May 29, 2004 (KR) 10-2004-0038645

(51) Int. Cl. G02F 1/1335; B05D 5/12

(52) U.S. Cl. 428/1.33; 428/1.3; 427/64

(57) ABSTRACT

Provided is a dust-free diffusion plate for a liquid crystal display (LCD) manufactured by coating and drying a conductive material to a thickness of no more than 2D on a surface of the diffusion plate to prevent degradation of image quality due to dust build-up on the diffusion plate.

### TECHNICAL FIELD

The present invention relates to a dust-free diffusion plate for a liquid crystal display (LCD) capable of obtaining a clear optical image by producing uniform optical diffusion. In particular, the present invention relates to a dust-free diffusion plate for an LCD wherein a dust-free coating layer is formed in order to prevent dust from adhering to a surface of the diffusion plate over time and degrading image quality by reducing transmittance and diffusion of the diffusion plate, and to enable a clear optical image to be obtained by producing uniform optical diffusion, and a method of fabricating the same.

### BACKGROUND ART

In a display device using a liquid crystal, light is diffused from a narrow fluorescent lamp made for driving the liquid crystal through a diffusion plate or a light guide plate typically formed of polycarbonate or acryl plate. In small and medium sized LCD devices, a fluorescent lamp serving as a light source which generates light is positioned at a side surface of an acryl or polycarbonate plate called a light guide plate, light is radiated from the side surface of the light guide plate to use the whole light guide plate as a flat light source, and a diffusion film is disposed thereon to uniformly spread the radiated light over the entire area. However, in large sized, for example, 32 inch or 40 inch LCD devices, due to difficulties in treating and manufacturing the narrow fluorescent lamp, light is not radiated from a side surface of the light guide plate, the fluorescent lamp is positioned at a rear surface of a polymer sheet referred to as a diffusion plate, and the light is diffused through the diffusion plate to radiate across the entire area with uniform intensity.

In an LCD device, a part where the diffusion plate is positioned cannot be completely shielded from the outside and as a result minute dust particles can flow into the part where the diffusion plate is positioned. The dust particles do not flow out but rather float around inside due to convection and then adhere to a surface of the diffusion plate. Over time, the dust on the surface of the diffusion plate builds up and degrades transmittance and diffusion performance of the diffusion plate, which degrades image quality of the LCD device.

In order to suppress this phenomenon, a filter capable of preventing inflow of dust may be disposed at an air inflow opening to block larger dust particles. However, such a filter cannot block minute dust particles from flowing inside and eventually adhering to the surface of the diffusion plate and degrading image quality.

Since the filter disposed at the air inflow opening cannot completely prevent dust from entering, the most effective solution is to provide a diffusion plate that itself prevents dust particles from adhering to its surface. In this case, transmittance of the diffusion plate should not be significantly reduced in making the diffusion plate dust-free. Accordingly, a diffusion plate capable of preventing dust from adhering to its surface, while not degrading transmittance, is needed.

In addition, optical characteristics such as high haze, total light transmittance, and so forth are essential characteristics of the diffusion plate. Thus, a diffusion plate capable of preventing dust from adhering to its surface and enhancing optical characteristics is needed.

### DISCLOSURE OF INVENTION

### Technical Problem

The present invention meets the above needs by providing a diffusion plate for a liquid crystal display (LCD) including a dust-free coating layer.

In addition, the present invention provides a dust-free diffusion plate for an LCD having enhanced transmittance and diffusion performance.

In addition, the present invention provides a method of manufacturing the diffusion plate.

### Technical Solution

In an embodiment of the present invention, a dust-free diffusion plate for an LCD is provided, which includes a transparent dust-free coating layer formed on a surface of the diffusion plate.

In another embodiment of the present invention, a method of manufacturing a dust-free diffusion plate for an LCD is provided, which includes: preparing a diffusion plate; and coating a dust-free coating solution on a surface of the diffusion plate.

According to the present invention, considering the fact that dust adheres to a polymer surface of the diffusion plate due to an electrostatic phenomenon, an appropriate method of preventing charges from accumulating on the surface or discharging the accumulated charges may be employed to prevent dust from adhering to the polymer surface. Accordingly, a method of coating an anti-static solution on a surface of the insulating diffusion plate capable of preventing dust from adhering thereto, while not significantly degrading transmittance in a visible range, is employed.

The dust-free coating solution for forming the coating layer in the present invention can be any anti-static liquid coating solution currently known in the art which after coating and drying yields a polymer surface whose surface resistance can be adjusted to be about 10³ to 10¹¹Ω/□. In the present invention, a representative coating solution capable of forming the coating layer includes a coating solution which contains only a conductive polymer or a conductive polymer mixed with a proper binder as an active component, and a coating solution in which metal oxide particles capable of being used as a conductive material and a proper binder are contained as active components and dispersed in a proper solvent, or a surfactant type coating solution such as a quaternary ammonium salt. Besides these examples, Indium-Tin-Oxide (ITO) used as a transparent electrode material may be formed on a surface of the diffusion plate by a sputtering method, a deposition method, or a sol gel method, to obtain the same effect.

When the conductive polymer is employed, it is possible to use a thermosetting type coating composition, and the coating solution may be manufactured by mixing a conductive polymer and a polymer binder. The coating solution preferably contains 0.05% to 10% by weight of conductive polymer, 5% to 40% by weight of polymer binder, and 50% to 94.95% by weight of solvent as a diluent. More preferably, the coating solution contains 1 to 5 parts by weight of thickener, 1 to 5 parts by weight of high boiling point solvent, 1 to 5 parts by weight of dispersible agent, and at least 0.01 to 0.1 parts by weight of adhesive and lubricant, based on the solution having a total of 100 parts by weight.

The conductive polymer includes a water-soluble or organic solvent type polymer, such as any one of polypyrrole, polyaniline, polythiophene, and their denatured conductive polymers such as polythiophene including an alkyl group composed of 5 to 12 carbons at a number 3 position, 3,4-polyethylenedioxythiophene by which an ethylene dioxy group is substituted at a number 3,4 position, or an alkoxy group including 1 to 4 carbons at a number 2,3 position, or either one of polyaniline having an amino group and a sulfonic group and pyrrole having an alkyl group composed of 5 to 12 carbons.

The conductive polymer is preferably provided in a coating composition as a water- or solvent-based solution according to characteristics of the polymer. The water-based conductive polymer solution includes Baytron PH™ (manufactured by H.C. Starck, Germany) in which a 1% concentration of polythiophene-based conductive polymer is dispersed in a solution, and the solvent-based solution includes W1-Green™ (manufactured by Ormecon GmbH, Germany) and Panipol Toluene Solution (manufactured by Panipol Co.), which are all commercially available conductive polymer coating solutions. Among the above-described conductive polymers, 3,4-polyethylenedioxythiophene is preferably used because of its superior transparency.

The composition ranges disclosed above are not intended to be strict limits. Variation outside of these ranges is possible within the scope of the present invention and will be apparent to those skilled in the art.

When the conductive polymer solution is only used at the time of coating, it is apt to be separated from a surface of a base polymer as a coating target or be dissolved in a solvent. Thus, it is necessary to add a binder to the solution.

The binder employed in the present invention includes a soluble binder and a solvent type binder, and one binder having at least one functional group among an acrylic functional group, a urethane functional group, an epoxy functional group, an amide functional group, an imide functional group, an ester functional group, a carboxyl functional group, a hydroxyl functional group, a silane functional group, a titanate functional group, and a silicate functional group may be used. Alternatively, a plurality of the above binders may be mixed and used.

The above-described binders are selectively added according to a characteristic of the solvent to be used, and in this case, an amount of binder added may vary according to a required resistance. When surface resistance ranges from 10⁴ to 10¹⁰Ω/□ in the present invention, the conductive polymer and the binder are preferably in a predetermined ratio.

In addition, when the binder contains a curable active component, in order to improve the material characteristics of the dust-free coating layer, a melamine hardener, an epoxy hardener, a weak organic acid-based hardener such as para-toluene sulfonic acid, and naphthalenesulfonic acid, an isocyanate hardener such as torilenisocyanate and methylbisisocyanate, an amine-based hardener, and an organic weak acid hardener may be employed. These hardeners may be selectively used according to a kind of cure reaction. When at least two cure reactions occur, it is possible to use at least one hardener in a range in which the reactivity is not lowered or too rapid. When the binder can be cured as described above, the hardener may be mixed and used, and the cure may gradually progress by heat generated within an LCD device during use even when an additional curing process is not performed, so that the layer can gradually solidify when an anti-static and dust-free hardener is used.

When a coating solution containing the conductive polymer is manufactured, there is no particular restriction on a dispersible agent for enhancing the dispersion characteristics. However, 1-methyl-2-pyrolelidinone, 1-methyl-pyrollidone, 2-methylpyrollidon, 1-methyl-3-pyrolerydiol, and so forth may be preferably used. The compound may act as a hardener at the time of drying and curing, and may act in advance to enhance conductivity by increasing an effective conduction length of the conductive polymer because of its excellent compatibility with conductive polymer chains.

An antioxidant may be used to suppress thermal oxidation degradation. The antioxidant may include hindered phenol such as pentaerythrityl-tetrakis[3-(3,5-di-tertiary-butyl-4-hydroxy phenyl)-propionate], octadecyl 3-(3,5-di-tertiary-butyl-4-hydroxy phenyl)-propionate, triethylene glycol-bis-3(3-tertiary-butyl-4-hydroxy-5-methylphenyl)propionate, 1,3,5-tris(3,5-di-tertiary-butyl-4-hydroxy benzyl S-triasine-2,4,6-(1H3H5H)trion, and thioethylene bis[3-(3,5-di-tertiary-butyl-4-hydroxyphenyl)propionate], tris-(2,4-di-tertiary-butyl phenyl)phosphite, and so forth. However, the antioxidant is not limited to these examples.

In addition, glycol and glycerol having a high boiling point may be used to adjust viscosity and to enhance dispersion. At least one of ethyleneglycol, diethyleneglycol, ethyleneglycolmonomethylether, ethyleneglycolmonoethylether, ethyleneglycolmonobutylether, ethyleneglycoldiethylether, diethyleneglycoldiethylether, glycerol, and glyceroldiglycidylether may be used.

At the time of coating, lubricant, antifoaming agent, and leveling agent may be used to improve liquidity, spreadability, and adhesive strength. In particular, non-ionic and ionic surfactants and silicon or florin-based surfactant compounds are preferable. Companies manufacturing such compounds include Dupont, Dowcorning, Shinetsu, Witco, 3M, and so forth. Any commercially available lubricant and antifoaming agent can be employed. These products are manufactured by various companies and may be selectively used according to material characteristics and intended effect.

The solvent for coating is appropriately selected according to whether the conductive polymer and the binder used are water-soluble, organic solvent-soluble, etc. Examples of the solvent include distilled water, alcohol having 1 to 4 carbon atoms such as methanol, ethanol, isopropanol, and normalbuthanol, and at least one kind of solvent selected from toluene, xylene, acetone, methylethylketone, ethylacetate, ethyleneglycolmonomethylether, ethyleneglycolmonoethylether, and ethyleneglycolmonobutylether. Preferably, two kinds of these solvents which are compatible with the entire composition and have high and low specific gravities may be selected and mixed to make up 50% to 94.95% by weight of the entire coating composition.

The binder component in the composition may employ titanate or silicate by itself or mixed with the above-described binder component in a weight ratio of (5:95) to (95:5). In general, it is known that the component of the silicate or the like must be cured for about 30 minutes at a temperature of about 150° C. in order to have a sufficient curing reaction. However, a curing reaction at a temperature of about 150° C. cannot be performed because the diffusion plate is a polymer sheet having a low heat-resistant characteristic. However, the diffusion plate can be gradually cured by heat generated from the inverter for supplying power and the light source. Accordingly, at the time of manufacturing the dust-free solution, these inorganic binders may be advantageously employed to gradually solidify the dust-free layer while the LCD is used.

In addition, although a little complicated, a vapor phase polymerization method and a direct polymerization method may be employed in which a conductive polymer monomer, an oxidizing agent, and a dopant are mixed to form the dust-free layer on the surface of the diffusion plate to a thickness of tens to hundreds of nanometers, thereby maintaining the same transparency, and generating dust repelling and anti-static characteristics.

In addition, since the layer is not used in such a way as to require durability, it does not need to have a hard material characteristic. However, the coating may be carried out using a UV-curable method in order to prevent scratches from occurring during processing.

A UV-curable anti-static composition is manufactured by mixing 1 to 20 parts by weight of conductive polymer, 1 to 30 parts by weight of UV-curable oligomer, 1 to 20 parts by weight of UV-curable monomer, 0.01 to 5 parts by weight of photoinitiator, 0.01 to 5 parts by weight of lubricant, 0.01 to 2 parts by weight of UV stabilizer, 0.01 to 1 parts by weight of reaction inhibitor, 0.01 to 1 parts by weight of antioxidant, and 16 to 96.95 parts by weight of solvent, and 1 to 10 parts by weight of cross-linking co-agent may be optionally added, based on a total of 100 parts.

As the conductive polymer in the composition, denatured conductive polymers such as polypyrrole, polyaniline, polythiophene, or poly(3,4-ethylenedioxythiophene) may be used. When the anti-static solution for coating the surface of an extrusion is employed, the conductive polymers have respective colors (for example, polypyrrole having a dark brown color, polyaniline having a dark green color, and polyethylenedioxythiophene having a pale blue color) so that it is most effective to use poly(3,4-ethylenedioxythiophene) having a pale blue color. In particular, in the case of poly(3,4-ethylenedioxythiophene), since it is possible to make it in a water-based form, it may be advantageous in preventing environmental contamination.

A example of the UV-curable binder resin may be made of monomers or oligomers. The monomers have a small molecular weight and a double bond which is readily broken by UV light to cause the curing reaction. The resin thus becomes a polymer resin having a large weight. The oligomer binder resin has a relatively large molecular weight and is usually acrylic resin or methacrylic resin having at least two organic functions and mainly having a urethane functional group, an epoxy functional group, an ester functional group, an acrylic functional group, a polybutadiene functional group, a silicon functional group, a melamine functional group, and a dendrimer functional group. As with the monomer binder resin, when UV light is radiated onto acrylate/methacrylate in the oligomer binder resin, a double bond is broken to form a polymer. In addition, among these oligomers having at least two organic functions, when an oligomer having at least six organic functions, which have been developed and used in recent years, in particular, an oligomer having 12 to 15 functional groups, is used, a coating characteristic including a fast curing speed and a hard material characteristic can be obtained. In addition, the curing can only progress with acrylate/methacrylate monomer. However, this monomer is brittle so it is preferable to mix it with an oligomer having multiple organic functions to enhance the material characteristics and increase curing speed.

Representative photoinitiators used for UV-curing may include benzyl dimethyl ketal, hydroxyl cyclohexyl phenylketone, hydroxydimethyl acetophenone, hydroxydiphenyl ethanol, 2,4,6-trimethylbenzoyldiphenylphosphine, benzoin isopropyl ether and benzophenone, 2-chlorodioxanon, isoprophyldioxanon, and so forth.

The cross-linking co-agent is a component which helps the UV-curing reaction when used together with the photoinitiator, and acts to increase hardness when an appropriate amount is used.

The lubricant is a fluorine, phosphor, or silicon-based surfactant and is used to enhance the liquidity of the coating solution and to help each component dissolved in the solvent. Denatured fluoric organic polysiloxane, low molecular and polymer polyacrylate, silicon polyacrylate, polyethyl denatured polysiloxane, fluoride denatured polysiloxane, and so forth can be used as the lubricant.

The UV stabilizer is a component used to suppress the phenomenon of a conjugate double bond being broken and degrading the conductivity when the conductive polymer is exposed to UV light. Various kinds of UV stabilizer may be employed, such as 2,4 dihydroxybenzophenone, 2-hydroxy-4-n-octoxybenzophenon, ethyl-2-cyano-3-3-diphenylacrylate, and so forth.

The reaction inhibitor capable of inhibiting further progression of UV curing may be a compound including various kinds of thiol. For example, the reaction inhibitor can be one kind or a mixture of at least two kinds of compounds with various substitute operational groups such as methyl mercaptan, ethyl mercaptan, normal prophyl mercaptan, isopropyl mercaptan, normal butyl mercaptan, isobutyl mercaptan, sec butyl mercaptan, tertiary butyl mercaptan, normal amyl mercaptan, iso amyl mercaptan, normal hexyl mercaptan, and dodecyl mercaptan. The reaction inhibitor has a double bond and is used to prevent further reaction which could cause anti-static performance to deteriorate over time. That is, the remaining initiator which participated in the reaction may not only disassemble the conductive polymer itself having the double bond when exposed to air, but also destabilize a doped state of the conductive polymer and the dopant and causes a change in the resistance. Thus, a method of creating an oxygen-free atmosphere in the initial stage of the reaction by injecting nitrogen or an inactive gas into a curing device can be used to perform curing sufficiently and increase hardness. It is very important to prevent over-reaction.

The antioxidant for suppressing thermal oxidation degradation may include tris-(2,4-di-tertiary-butyl phenyl)phosphate and hindered phenol such as pentaerythrityl-tetrakis[3-(3,5-di-tertiary-butyl-4-hydroxyphenyl)-propionate], octadecyl 3-(3,5-di-tertiary-butyl-4-hydroxy phenyl)-propionate, triethylene glycol-bis-3(3-tertiary-butyl-4-hydroxy-5-methylphenyl)propionate, 1,3,5-tris(3,5-di-tertiary-butyl-4-hydroxy benzyl S-triazin-2,4,6-(1H3H5H)trion, and thioethylene bis[3-(3,5-di-tertiary-butyl-4-hydroxyphenyl)propionate], but is not limited to these examples.

Glycol and glycerol having a high boiling point may be used in order to adjust the viscosity and enhance dispersion. Such glycol and glycerol may be at least one selected from the group consisting of ethyleneglycol, diethyleneglycol, ethyleneglycolmonomethylether, ethyleneglycolmonoethylether, ethyleneglycolmonobutylether, ethyleneglycoldiethylether, diethyleneglycoldiethylether, glycerol, and glyceroldiglycidylether.

At the time of coating, as additives such as lubricants for improving liquidity, spreadability, adhesive strength, in particular, ionic and non-ionic surfactants, and silicon or florin-based surfactant compounds may be preferably used. Companies manufacturing such compounds may include Dupont, Dowcorning, Shinetsu, Witco, 3M, and so forth. However, any commercially available lubricants and antifoaming agents can be employed as additives to the solution, and such additives are not limited to products manufactured by the above companies. Additives may be selectively used according to material characteristics and intended effect.

The kind of solvent capable of being used for the present composition may include alcohol having 1 to 4 carbons such as methanol, ethanol, isopropanol, propanol, butanol, isobutanol, and so forth, amide-based solvents such as N-methyl-2-pyrrolelidon, 2-pyrollidone, N-vinyl-2-pyrollidone, N-methylformamide, N,N-dimethylformamide, and so forth, and ether-based solvents such as acetone, ethylacetate, butylacetate, toluene, chloroform, methylenechloride, and polyhydric alcohol such as ethyleneglycol, glycerol, ethyleneglycol monomethylether, ethyleneglycolmonoethylether, and ethyleneglycolmonobutylether. Here, at least one of the above kinds of solvents can be used, and when two kinds are mixed, a mixing ratio of 5:95 to 95:5 is preferable.

In addition to the above-described UV-curable composition, the conductive polymer is coated using a thermosetting method and the single component of the UV-curable composition is coated thereon and cured again, so that a coating product which has an increased durability against solvents such as alcohol and is not readily stripped off by friction can be manufactured. As described above, this is a good method because the general conductive polymer composition is apt to be stripped off by friction or readily wiped off by solvent. In addition, the method of forming the protective layer may use not only the UV-curable composition but also a composition capable of being cured by heat.

The principle is as follows. When the conductive polymer is mixed in to provide anti-static performance, material characteristics of the thermosetting polymer binder and the UV hardener deteriorate. And, after basic coating of the conductive polymer and the UV hardener, if a highly durable UV hardener or thermosetting agent is coated on top, a highly durable coating layer can be obtained. However, this disadvantageously requires that two coating processes be performed.

When the dust-free coating solution uses the metal oxide particles as a main active component, the solution contains 10% to 40% by weight of metal oxide particles such as doped indium oxide, doped tin oxide, and doped titanium oxide, mixed with 10% to 40% by weight of one low molecular and one polymer binder, or at least one thereof, having at least one functional group such as a urethane functional group, an acrylic functional group, an amide functional group, an imide functional group, an epoxy functional group, a silane functional group, and a carboxyl functional group, and 20% to 80% by weight of a dispersible solvent. At least one of 0.5 to 2 parts by weight of thickener, 0.5 to 2 parts by weight of dispersible agent, 0.1 to 1 part by weight of antioxidant, and 0.1 to 1 part by weight of lubricant, based on the solution having 100 parts by weight, may be added to the solution if necessary. Since the metal oxide particles may reduce the transmittance by scattering incident light, their concentration must be as low as possible. In this case, examples of a proper solvent include a water-based solvent such as water or alcohol in the case of a water-soluble binder, and an organic solvent such as toluene, alcohol, methyletherketone, ethylacetate, acetone, chloroform, xylene, trihydropuran, and so forth. In addition, when compounds such as ethyleneglycolmonomethylether, ethyleneglycolmonoether, ethyleneglycolmonobutylether, and so forth are used, water-based and organic solvent compounds may be combined and used without any precipitation up to a certain concentration.

In addition, the anti-static and dust-repelling agent which is formed by ionic and non-ionic surfactants such as ionic quaternary ammonium may be coated by diluting it with water or alcohol. Here, whichever one of water and alcohol enables the characteristics of the agent to be permanently maintained is preferably employed.

In the meantime, when the conductive polymer having a thiophene group, an aniline group, a pyrrole group, and so forth is used as the anti-static composition, optical characteristics such as a high haze or total light transmittance are obtained. In particular, a composite layer of a binder resin mixed with a water-based solution of poly(3,4-dioxythiophene) as the polythiophene-based denatured conductive polymer shows relatively superior optical characteristics compared to other conductive polymers. The coating layer is preferably formed on one or both surfaces of the diffusion substrate in consideration of optical characteristics, and a small amount of light diffusion agent may be mixed therewith in order to further enhance optical characteristics. Transparent particles or white particles are preferably used as the light diffusion agent. The transparent particles may include organic particles such as acrylic particles, styrene particles, silicon particles, and the like, and inorganic particles such as synthetic silica, glass bead, diamond, and the like. In addition, examples of the white particles include titanium oxide, zinc oxide, barium sulfate, calcium carbonate, magnesium carbonate, aluminum hydroxide, clay, and so forth, and one or more kinds of these transparent particles and white particles may be mixed and used as the light diffusion agent. The proper size of the light diffusion agent is about 1 to 50□, and particles having different sizes may be mixed and used.

### ADVANTAGEOUS EFFECTS

According to the present invention, a diffusion plate for an LCD which does not collect dust even when used for a long time, and has superior anti-static performance in a dusty environment, and associated plastic components, can be manufactured.

In addition, according to the present invention, a diffusion plate for an LCD that exhibits dust-repelling, increased diffusion and high transmittance characteristics, and associated plastic components, can be manufactured.

### BRIEF DESCRIPTION OF THE DRAWINGS

The above and other features of the present invention will be described with reference to exemplary embodiments thereof illustrated in the attached drawings, in which:

FIG. 1 is a cross-sectional view of a diffusion plate in accordance with an embodiment of the present invention;

FIG. 2 is a cross-sectional view of a diffusion plate having enhanced diffusion and transmittance characteristics in accordance with an embodiment of the present invention; and

FIG. 3 is a view for explaining optical characteristics of a diffusion plate in accordance with the present invention.

### BEST MODE FOR CARRYING OUT THE INVENTION

Hereinafter, a diffusion plate according to the present invention will be described more fully with reference to the accompanying drawings.

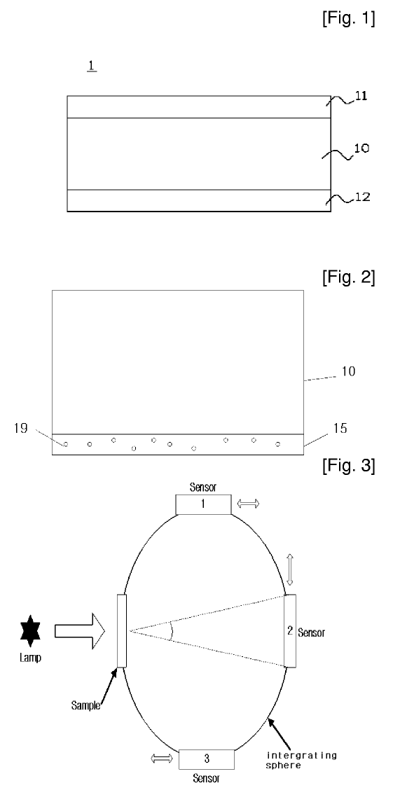

FIG. 1 is a cross-sectional view of a diffusion plate 1 according to the present invention. A conventional base substrate 10 may be employed. The base substrate 10 has a single layer or multi-layered structure, and a tri-layered structure may be typically employed as the multi-layered structure. An upper coating layer 11 and a lower coating layer 12 are formed on and under the base substrate 10, respectively, using a coating solution. While the coating layers are formed both on and under the base substrate 10 in FIG. 1, alternatively, only one coating layer may be formed on a required surface of the base substrate 10. Any one surface of the base substrate 10 may be entirely or partially coated, however it is preferable to coat the entire surface for the dust-free performance. As shown in FIG. 1, when the coating layers 11 and 12 are formed on and under the base substrate 10, they need to be grounded at the upper and lower portions, respectively, and when the coating layer is formed on the entire surface, only a specific portion of the diffusion plate 1 may be grounded. When a required specific portion of the base substrate 10 is coated, the grounding needs to be done in response to the resultant structure.

FIG. 2 is a cross-sectional view of a diffusion plate in accordance with another embodiment of the present invention. A base substrate 10 is the same as FIG. 1 and formed on one surface of a coating layer 15, and the coating layer 15 is formed using a conductive polymer material having a thiophene group, an aniline group, a pyrol group and so forth so as to increase dispersion and transmittance of the diffusion plate. In addition, a small amount of light diffusion agent 19 is mixed thereto in order to further enhance optical characteristics. The coating layer 15 is preferably formed on one surface or both surfaces of the base substrate 10 in consideration of optical characteristics.

FIG. 3 is a view for explaining the optical characteristics of a diffusion plate according to the present invention, and optical characteristics associated with the diffusion plate are as follows.

HZ(%)=haze=DF/TT×100

TT(%)=total light transmittance=the amount of measured light at all of the sensors/reference amount of light×100

DF(%)=diffuse transmittance=the amount of light measured at the sensors 1 and 3/the amount of light measured at all of the sensors×100

PT(%)=parallel transmittance=the amount of light measured at the sensor 2/the amount of light measured at all of the sensors×100

Haze is a value representing the amount of diffused light among light which is totally transmitted, and is the most important measurement for evaluating the performance of the diffusion plate. Diffuse transmittance is the amount of light scattered and transmitted divided by the total amount of light transmitted, and is expressed as a percentage. Parallel transmittance is the amount of light transmitted without being scattered divided by the total amount of light transmitted, and is expressed as a percentage. Total light transmittance is the sum of diffuse transmittance and parallel transmittance and is generally 95% to 100% for the diffusion plate. Accordingly, the larger the haze, total light transmittance, and diffuse transmittance, and the smaller the parallel transmittance, the better the diffusion plate.

A method of forming a dust-free coating solution to the diffusion plate may include an infiltration method, a spray method, a roll coating method, a bar coating method, a gravure method, a reverse gravure method, and a deep coating (immersion) method, and any one or more of these methods may be used. For example, the coating solution is first coated on the surface of the diffusion plate by means of the spray method, and a subsequent method of making the thickness of the coating layer uniform using a roll or bar coater may be used. In addition, both surfaces of the diffusion plate may be simultaneously coated using the infiltration method.

When the diffusion plate is cut to a predetermined size and then deep coated (immersed), every surface thereof has dust-free performance. In this case, as long as the dust-free, anti-static agent is mixed into the coating material, a resistance between an upper plate and ground is the same in an environment in which the diffusion plate is actually used as when it is connected to a work table having a discharge function. Accordingly, superior anti-static performance which prevents friction charging, decay time, and so forth, can be advantageously obtained.

In the case of the above-described infiltration, since the coating layer is typically thick, it is effective to add less solid component to the coating solution compared to other coating methods. And, when the infiltration method is employed, dust-free coating can be performed on various plastic components and the reflective plate, in addition to the diffusion plate.

The thickness of the coating layer after it dries is important. When the layer is thick, dust-free performance is better but transmittance is degraded. When the thickness of the dried layer is about 0.01□ to 2□, transmittance loss can be adjusted to within 2% compared to the transparency of the matrix polymer.

In general, the diffusion plate is manufactured by an extruding method, and when an organic solvent contacts the polymer sheet after extrusion, fine cracks occur on the surface of the polymer sheet. To prevent such fine cracks, water not mixed with alcohol may be used as the coating solution solvent, or the extruded sheet may be left at room temperature for one day or more before coating it with the dust-free coating solution.

In some cases, the coating solution containing only water has poor liquidity because surface tension of the polymer surface is too low. In such cases, the polymer surface may be subjected to corona processing, or may be first processed with the coating solution containing water and a primer such as an acrylic-based primer, a urethane-based primer, an epoxy-based primer, and so forth, and then recoated, to enhance liquidity and adhesion characteristics. However, even with these additional processes, the water solvent evaporates too slowly. Thus, when only water is used as a solvent, processing speed is slow and a processing line is long.

When the extruded material is left at room temperature for one day or more as described above, fine cracks may be prevented, however the extrusion and coating cannot be performed in a batch manner using an automated manufacturing line.

Accordingly, the best method is to perform extrusion followed immediately by coating on a manufacturing line. A first coating solution using only water as a solvent is coated and dried, and then a second coating solution containing a highly volatile alcohol which is quaternary or less is coated again, thereby performing extrusion and coating back-to-back.

### MODE FOR THE INVENTION

Hereinafter, exemplary embodiments of the present invention will be described in detail. The following exemplary embodiments are not intended to limit the scope of the present invention.

### First Comparative Example

A diffusion plate (made by “A” company in Japan) of a conventional LCD that was not subjected to anti-static treatment was cut into a 10 cm by 10 cm square, put into a chamber filled with floating dust having an average size of 1.0□ for ten minutes, and then taken out. Next, both surfaces of the diffusion plate were cleaned with 100 ml of ultra pure water by ultrasonic processing for ten minutes and the number of dust particles removed from the diffusion plate was measured by means of a liquid particle counter.

The number of dust particles measured through the above-described experiment was 105,500.

### Second Comparative Example

The same experiment as in the first comparative example was performed on a diffusion plate (made by “A” company in Japan, surface resistance of 10¹²Ω/□ or more) of a conventional LCD that was subjected to anti-static treatment.

The number of dust particles measured through the experiment was 87,000.

### Third Comparative Example

The triboelectricity of the Japanese-made diffusion plate subjected to anti-static treatment and used in the second comparative example was measured using a 718 STATIC SENSOR made by 3M. When the measurement was performed according to the ESD ADV 11.2 method, the result was 700V, and when a protective film attached to the diffusion plate was removed and the measurement was performed according to the FTMS 101C method, the result was 1100V.

### First Exemplary Embodiment

10 g of poly(3,4-ethylenedioxythiophene) dispersible solution (Baytron P H, H. C. Starck, Germany), 20 g of urethane binder (u710; ALBERDINGK U710. Germany), 0.01 g of melamine hardener, 1 g of ethyleneglycol, 1 g of N-methyl2-pyrrolidinone, and 0.01 g of florin lubricant were mixed in 67.99 g of solvent containing 15% water and 85% isopropyl to form a dust-free solution, which was then coated and dried on both surfaces of a 10 cm by 10 cm square diffusion plate, thereby forming a dust-free layer having a thickness of 0.2□. The surface resistance after coating was 10⁵Ω/□. The experimental method of the first comparative example was performed and the number of dust particles removed from the surface of the processed diffusion plate was measured.

In the case of the diffusion plate processed using the method of the first exemplary embodiment, the measured number of dust particles was only fifteen, which means that almost no dust adhered to the diffusion plate.

### Second Exemplary Embodiment

5 g of poly(3,4-ethylenedioxythiophene), 5 g of 6-functional urethane acrylate oligomer, 5 g of 12-functional epoxy acrylate oligomer, 5 g of 2-functional monomer acrylate, 0.1 g of hydroxy dimethylacetophenone as an initiator, 0.01 g of polyethyl denatured polysiloxane additive, 40 g of isopropyl alcohol, and 39.89 g of ethyleneglycolmonomethylether were mixed, and the mixture was coated on both surfaces of a 10 cm by 10 cm square diffusion plate to a thickness of 0.5□ and dried for one minute at 60° C. and 400 mJ was applied from a UV coating device to cure it. The surface resistance after curing was 10⁶Ω/□. The experimental method of the first comparative example was performed and the number of dust particles removed from the surface of the processed diffusion plate was measured.

In the case of the diffusion plate processed using the method of the second exemplary embodiment, the number of dust particles measured was only seventeen, which means that almost no dust adhered to the diffusion plate.

### Third Exemplary Embodiment

The triboelectricity of the diffusion plate coated with the conductive polymer manufactured according to the second exemplary embodiment was measured using a 718 STATIC SENSOR made by 3M. When the measurement was performed according to the ESD ADV 11.2 method, the result was 21V, and when a protective film attached to the diffusion plate was removed and the measurement was performed according to the FTMS 101C method, the result was 90V.

### Fourth Exemplary Embodiment

The conductive polymer manufactured according to the second exemplary embodiment was coated on a 100□-thick PET film to a thickness of 0.5□ and transparency in a visible region (550 nm) was measured using a UV-visible spectrophotometer.

It was observed that transparency decreased by 1.2% after the coating process was carried out.

(In this experiment, the composition was coated on the transparent PET film rather than a diffusion plate having a low visible ray transmittance in order to check the visible ray transmittance of the composition itself.)

### Fifth Exemplary Embodiment

The conductive polymer composition manufactured according to the first exemplary embodiment was coated and dried on one surface of the diffusion plate to form an anti-static and dust-free layer, and the total light transmittance was measured according to the ASTM D-1003 method. The measurement apparatus was an NDH-2000 of Nippon denshoku Industries Co., LTD.

The total light transmittance was 100% that of a diffusion plate not coated with the conductive polymer composition, and the diffuse transmittance (haze) was 92.1%, which represents a 2% increase compared to the non-coated diffusion plate.

### Sixth Exemplary Embodiment

One surface of a diffusion plate was coated with a conductive polymer composition manufactured according to the first exemplary embodiment, which includes 10 g of poly(3,4-ethylenedioxythiophene) dispersible solution, 20 g of urethane binder (U710; available by ALBEWRDINGK, Germany), 0.01 g of melamine hardener, 1 g of ethylene glycol, 1 g of N-methyl2-pyrrolelidinone, 0.01 g of florin lubricant, 3 g of a light diffusion agent (MX150, Soken), and a 15% water, 85% isopropylalcohol solvent, and dried to form an anti-static and dust-free layer. The total light transmittance was measured according to the ASTM D-1003 method. The measurement apparatus was an NDH-2000 of Nippon denshoku Industries Co., LTD.

The total light transmittance was 100% that of a diffusion plate not coated with the conductive polymer composition, and the diffuse transmittance (haze) was 92.4%, which represents a 2.3% increase compared to the non-coated diffusion plate.

### INDUSTRIAL APPLICABILITY

When the above results of the comparative example and the exemplary embodiments are compared, the anti-static processed and unprocessed diffusion plates currently on the market cannot prevent dust from adhering to their surfaces, and significant amounts of dust adhere to their surfaces because of frequently occurring electrostatic phenomena. However, the dust-free and anti-static processed diffusion plate using the conductive polymer composition manufactured according to the first and second exemplary embodiments of the present invention can prevent adherence of dust during processing, and can prevent reduction of the lifespan of a large-sized display after its assembly by preventing adherence of dust during usage of the display, thanks to a superior dust-free effect. In addition, it was confirmed that a thin film coating of the conductive polymer composition not only has a dust-free effect due to anti-static performance but also has increased diffuse transmittance which is an important optical characteristic.

1. A dust-free diffusion plate for a liquid crystal display (LCD), comprising:
a transparent dust-free coating layer formed on a surface of the diffusion plate using a composition having a conductive polymer as an active component.

2. The dust-free diffusion plate for an LCD according to claim 1, wherein the composition contains 0.05% to 10% by weight of the conductive polymer, 5% to 40% by weight of a polymer binder, and 50% to 94.95% by weight of a dispersible solvent, and the composition is formed into the transparent dust-free coating layer using a thermosetting method.

3. The dust-free diffusion plate for an LCD according to claim 2, wherein at least one binder having at least one functional group among an acrylic functional group, a urethane functional group, an epoxy functional group, an amide functional group, an imide functional group, an ester functional group, a carboxyl functional group, a hydroxyl functional group, a silane functional group, a titanate functional group, and a silicate functional group is used as the polymer binder.

4. The dust-free diffusion plate for an LCD according to claim 1, wherein the composition is cured to form the transparent dust-free coating layer using an ultraviolet (UV) curing method.

5. The dust-free diffusion plate for an LCD according to claim 4, wherein the composition contains 0.05% to 20% by weight of the conductive polymer, 10% to 50% by weight of a UV-curable binder, 0.5% to 5% by weight of a photoinitiator, and 25% to 89.45% by weight of a solvent.

6. The dust-free diffusion plate for an LCD according to claim 4, wherein at least one binder used contains a UV-curable oligomer that has an acrylate/methacrylate with 2 to 12 functional groups, and a monomer that has an acrylate/methacrylate with 1 to 6 functional groups.

7. The dust-free diffusion plate for an LCD according to claim 1, wherein the composition uses as an active component a conductive polymer including at least one denatured conductive polymer such as polyaniline, polypyrrole, polythiophene, and poly 3,4-ethylenedioxythiophene, or alternatively further includes a small amount of light diffusion agent to increase diffuse transmittance.

8. The dust-free diffusion plate for an LCD according to claim 1, wherein a surface resistance of the transparent dust-free coating layer formed from the composition including the conductive polymer is 10E3 to 10E11Ω/□.

9. The dust-free diffusion plate for an LCD according to claim 1, wherein the transparent dust-free coating layer formed from the composition including the conductive polymer has an anti-static characteristic of less than 100V of frictional voltage.

10. The dust-free diffusion plate for an LCD according to claim 1, wherein the thickness of the transparent dust-free coating layer has a range of 0.005 to 2 μm so that a decrease in transmittance becomes no more than 2% compared to an existing unprocessed diffusion plate.

11. A method of manufacturing a dust-free diffusion plate for an LCD, comprising:
preparing a diffusion plate; and
coating a surface of the diffusion plate with a dust-free coating solution using a conductive polymer as an active component.

12. The method according to claim 11, wherein coating the surface of the diffusion plate includes first coating the surface of the diffusion plate with a coating solution using only water as a solvent and drying the solution, and then recoating the surface of the diffusion plate with a coating solution containing a highly volatile, quaternary or less alcoholic solvent.

13. The method according to claim 11, wherein the coating solution is coated using at least one of a roll coating method, a bar coating method, a gravure method, a reverse gravure method, a spray method, and an infiltration method.

14. The method according to claim 11, wherein the conductive polymer is formed using a vapor phase polymerization method.

15. The method according to claim 11, wherein the conductive polymer is polymerized using at least one of aniline, pyrrole, thiophene, 3,4-ethylenedioxythiophene, and denatured monomers.

16. The method according to claim 11, wherein coating is performed using, as an active component, a conductive polymer including at least one of polyaniline, polypyrrole, polythiophene, poly 3,4-ethylenedioxythiophene, and a denatured conductive polymer, or alternatively a coating agent further including a small amount of light diffusion agent to increase diffuse transmittance.

17. The dust-free diffusion plate for an LCD according to claim 5, wherein at least one binder used contains a UV-curable oligomer that has an acrylate/methacrylate with 2 to 12 functional groups, and a monomer that has an acrylate/methacrylate with 1 to 6 functional groups.

18. The dust-free diffusion plate for an LCD according to claim 2, wherein a surface resistance of the transparent dust-free coating layer formed from the composition including the conductive polymer is 10E3 to 10E11 Ω/□.

19. The dust-free diffusion plate for an LCD according to claim 2, wherein the transparent dust-free coating layer formed from the composition including the conductive polymer has an anti-static characteristic of less than 100V of frictional voltage.

20. The dust-free diffusion plate for an LCD according to claim 2, wherein the thickness of the transparent dust-free coating layer has a range of 0.005 to 2 μm so that a decrease in transmittance becomes no more than 2% compared to an existing unprocessed diffusion plate.
